(19) United States
(12) Patent Application Publication
(10) Pub. No.: US 2026/0140751 A1
(43) Pub. Date: May 21, 2026

(54) FAST ACCESS OPERATIONS SYSTEM

(71) Applicant: SAP SE, Walldorf (DE)

(72) Inventors: Aravinth A C, Bangalore (IN); Dileep MOHANAN, Bangalore (IN); Manvi FOTEDAR, Bangalore (IN); Riddhi DEDHIA, Bangalore (IN); Santhosh RAO, Bangalore (IN)

(21) Appl. No.: 18/953,226

(22) Filed: Nov. 20, 2024

(51) Int. Cl. G06F 9/451; H04L 67/50

(52) U.S. Cl. CPC G06F 9/453; H04L 67/535

(57) ABSTRACT

System, method, and various embodiments for a fast access operations system, are described herein. An embodiment operates by tracking a plurality of user interactions performed with a first application. A user interface comprising both the tracked plurality of user interactions and a second application is provided. A selection of a first user interaction of the first application from the tracked plurality of user interactions is received. The first application is provided after a performance of the first user interaction corresponding to the selection.

### BACKGROUND

Computer systems have been heavily integrated into today's workforce. Most people use mobile phones, laptop computers, tablet computers, etc. to assist them in their employment objectives (e.g., Enterprise Resource Planning (ERP) software). For some employees, interacting with multiple enterprise applications within a relatively short time frame, can leave the employee overwhelmed if they need to access a particular data point of one business object associated with one application after having opened or accessed multiple business objects across multiple applications.

### BRIEF DESCRIPTION OF THE DRAWINGS

The accompanying drawings are incorporated herein and form a part of the specification.

FIG. 1 is a block diagram illustrating an example fast access operations system (FAST), according to some embodiments.

FIGS. 2A and 2B illustrate an example user interface of a fast access operations system (FAST), according to some embodiments.

FIG. 3 is a flowchart illustrating example operations for providing a fast access operations system (FAST), according to some embodiments.

FIG. 4 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a fast access operations system.

Computer systems have been heavily integrated into today's workforce. Most people use mobile phones, laptop computers, tablet computers, etc. to assist them in their employment objectives (e.g., Enterprise Resource Planning (ERP) software). For some employees, interacting with multiple enterprise applications within a relatively short time frame, can leave the employee overwhelmed if they need to access a particular data point of one business object associated with one application after having opened or accessed multiple business objects across multiple applications.

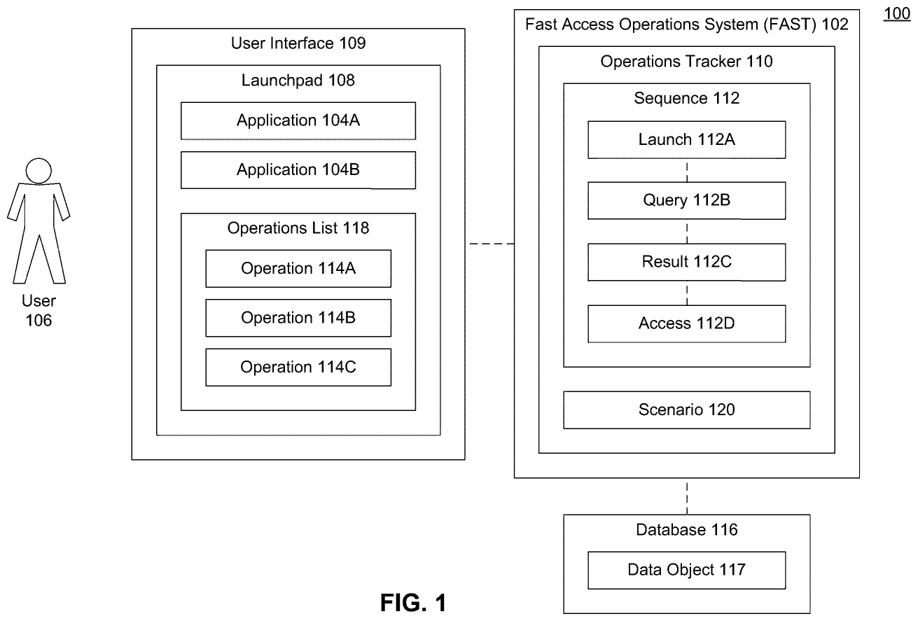

FIG. 1 is a block diagram 100 illustrating an example fast access operations system (FAST) 102, according to some embodiments. FAST 102 may track user interactions, actions, or operations across a variety of different applications 104A, 104B, and provide the user 106 with quick access to previously performed actions or detected interactions across different applications 104A, 104B. FAST 102 may reduce or minimize the amount of navigation, clicks, or other input that would otherwise be required by the user 106 to navigate between and perform operations across different applications 104A, 104B. In some embodiments, FAST 102 may allow a user 106 to select and automatically replay past actions (which may include multiple actions performed in a sequence) or retrieve past results, across different applications 104A, 104B with a single click.

Applications 104A, 104B (referred to herein generally as application 104 or applications 104) may include any computer program that is operated locally at a user device and/or in communication with one or more devices across a network. Examples of an application 104 include an app, computer program, web application, or other executable code or functionality. In some embodiments, applications 104 may be part of the same enterprise system.

In some embodiments, the applications 104 may be executable or may be launched from a Launchpad 108. Launchpad 108 may include a home screen, operating system, or other application from which a user 106 may select and access or launch the applications 104. For example, the user 106 may select icons or other user interface elements that when selected launch, open, or otherwise access a particular application 104. Launching an application 104 may include uploading or moving code of the application into operational memory (e.g., from disk storage, network storage, or another storage location), and executing the code.

In some embodiments, Launchpad 108 may be displayed in a user interface 109. User interface 109 may refer to the screen of or monitor connected to any computing device (e.g., mobile phone, tablet, laptop, desktop, SMART television, or other internet of things (IoT) device).

In some embodiments, when a user 106 launches an application 104A, the application 104A may consume the viewing space of user interface 109, or may be displayed in a tab or window of user interface 109. Then, for example, if user 106 wants to access a different application 104B, the user 106 may need to first navigate back to the Launchpad 108 and then launch or access another application 104B. This itself requires multiple user inputs (e.g., mouse clicks, user interface selections, button presses) and also requires the user to navigate multiple interfaces outside of application 104A. Then, if the user 106 wants to perform an operation or activity on application 104B, this requires additional user inputs, time, and navigation. In some embodiments, FAST 102 may reduce or minimize the number of interactions or amount of input required by the user 106 to both toggle between applications 104A, 104B, but also perform certain (previously performed) and tracked actions.

In some embodiments, Launchpad 108 may include an enterprise software landscape. In some embodiments, in using the enterprise landscape of Launchpad 108, a user may not open and close an application 104 in the traditional sense (i.e., when a file is closed and/or an application is exited, the user no longer works on it). Instead, the user 106, through the enterprise software landscape, opens and accesses multiple applications 104 that may be used to perform their job, which may include navigating back-and-forth between applications 104 and data objects 117 which have been previously accessed. Even if a previously accessed application 104 is closed, the user 106 may still need to return to it later, which would conventionally require the user to close or navigate out of their current application, return to the home screen, and re-launch the previously accessed application. This process requires numerous user inputs and time, and is prone to user errors.

In some embodiments, an operations tracker 110 (referred to herein as tracker 110) may track the inputs, actions, or other operations performed by user 106 with respect to Launchpad 108 and the various applications 104 accessible via Launchpad 108. For example, tracker 110 may monitor and log which applications 104 are opened, and what functionality is requested or operations are performed in those applications 104, what data is returned and/or accessed, and the order of these and other operations or interactions.

In some embodiments, tracker 110 may monitor or track which data objects 117 are accessed via different applications 104. A data object 117 may include a digital representation of a real world entity, such as a business entity, including, for example, an invoice, customer details, a single resource plan, etc. These individual entities support various processes across the enterprise software landscape. In some embodiments, a data object 117 may be generated by assembling relevant pieces of information pulled together using one or more APIs (application programming interfaces). In some embodiments, the user 106 can inspect and act on or access the data object 117 based on permissions.

Many data objects 117 in applications 104 allow for CRUD operations (e.g., create, read, update and delete). A CRUD operation on one data object 117 in one application 104A might affect the status of one or more data objects 117 in one or more other applications 104B. In some embodiments, the same data object 117 may be accessed in multiple different ways (or through multiple different applications 104). In some embodiments, tracker 110 may track (and log) both which data object(s) 117 were accessed by the user 106, which CRUD operation was performed with respect to the data object 117, and what functionality or application 104 was used for accessing the data object 117. In some embodiments, tracker 110 may store the recently accessed data object(s) 117 in a cache.

In some embodiments, tracker 110 may track operations across multiple computing sessions, which may include one or more device reboots, and applications 104 being opened and closed. In some embodiments, tracker 110 may track operations performed by the same user 106 (or user account) across different devices. For example, user 106 may have access to Launchpad 108 and/or one or more applications 104 from their mobile phone, tablet, and laptop computer. Tracker 110 may track the interactions by user 106 across all these devices, which are logged into with the same user account.

In some embodiments, tracker 110 may track, monitor, or log a sequence 112 of one or more actions or operations that are performed with regard to or across one or more applications 104. Sequence 112 illustrates an example set of steps, actions, or operations that may be monitored, tracked, and logged by operations tracker 110 with regard to Launchpad 108, applications 104, and data objects 117.

For example, at 112A, a user 106 may launch an application 104. At 112B, the user 106 may perform a search operation or query, which may include entering one or more strings or other inputs as search criteria. At 112C, the query may be executed against a database 116 and search results may be returned. In some embodiments, the results may include one or more data objects 117. At 112D, the user 106 may then access the one or more data objects 117 to perform a one or more CRUD operations.

In some embodiments, database 116 may include one or more data storage devices or mechanisms. In some embodiments, database 116 may include a server that provides data in response to a query or data that is to be used by or displayed via an application 104. For simplicity, a single data object 117 is illustrated in database 116, but it is understood that database 116 may store any number of data objects 117 across one or more storage devices, which may or may not be networked together.

In some embodiments, FAST 102 may provide user 106 access to the tracked sequences 112 (of one or more actions or operations) via an operations list 118. Operations list 118 may include a user interface element (e.g., window, menu, pop-up, etc.) that includes a listing of one or more operations 114A-C (referred to herein generally as operation 114 or operations 114). The operations 114 may include the actions, input, outcomes (e.g., search results), or other functionality requested or performed by a user 106 (or user account) as detected by operations tracker 110. In some embodiments, each operation 114 may correspond to a sequence 112 of one or more steps 112A-D which were tracked and logged by tracker 110 and may span multiple different applications 104.

As noted above, the operations 114 may span across multiple computing sessions and/or computing devices. In some embodiments, the user 106 may have the option to filter the operations 114 by computing sessions and/or computing device to make their search or identification of a relevant operation 114 easier.

Operations list 118 may allow a user 106 to quickly request or replay previously performed operations and/or quickly access previously accessed or cached data (e.g., data objects 117), across different applications 104.

For example, user 106 may perform operations on application 104A which are monitored and logged or otherwise tracked by tracker 110. The operations may include launching application 104A, performing several queries for information (receiving different sets of query results), opening a file, closing the file, and updating a data object 117.

In some embodiments, the operations performed by the user 106 could include the user 106 opening other applications 104 (e.g., not included in FIG. 1), and toggling back-and-forth between multiple different applications 104 and/or data objects 117. These various operations or sequences 112 across the different applications 104 of Launchpad 108 may also be logged or tracked by operations tracker 110.

In continuing the example above, user 106 may open and may be performing operations in application 104B. However, the user 106 may want to perform a previously performed operation with regard to application 104A (which may already be closed), or the operation may have been performed on a different device in a previous or different computing session. For example, the user 106 may want to access a data object 117 for a sales invoice that the user 106 previously searched for and updated, but that is only accessible through application 104A.

Conventionally, the user would have to close or at least navigate out of the open application, return to the home screen, launch the previous application again, re-enter the search parameters, perform the search, identify the same data object from the results, and re-select and re-open the data object. This is a tedious process involving many different steps or inputs from the user, which also includes the problem that may not remember all of their previous search criteria or which exact sales invoice was selected because several invoices may have been returned as part of the search result.

FAST 102, reduces the number of inputs that are required by the user to access or replay previously performed functionality across applications 104 without requiring the user to remember all of their previous steps. For example, operations list 118 may be accessible directly from application 104B or from Launchpad 108. In some embodiments, user interface 109 may simultaneously display both the active application 104B and operations list 118 with operations 114 performed across one or more other different applications, such as application 104A. The operations list 118 may provide the user 106 with a shortcut to perform, replay, or access one or more previously performed operations or results with regard to any previously accessed application 104 accessible from Launchpad 108. Even applications 104 which may have already been closed by the user 106.

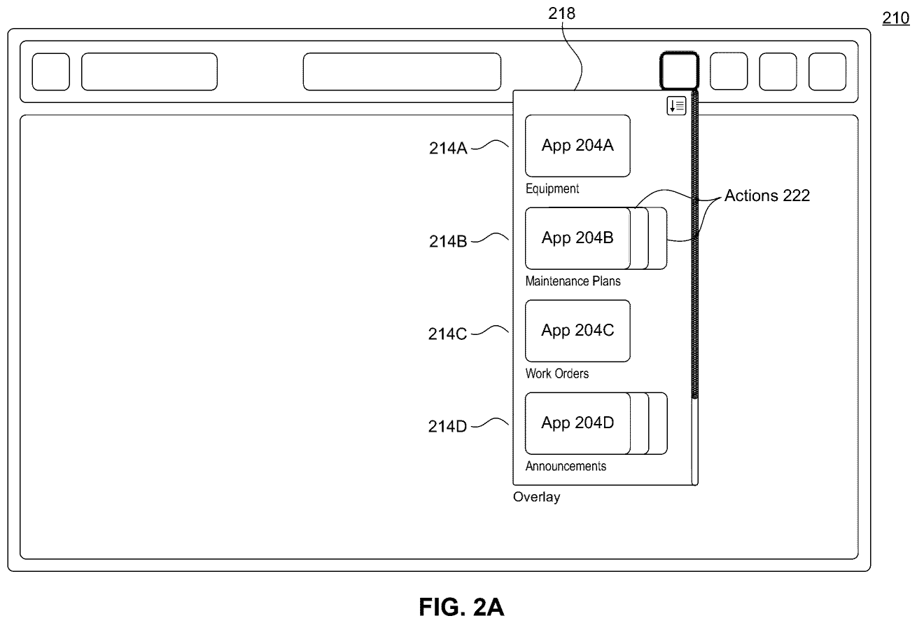

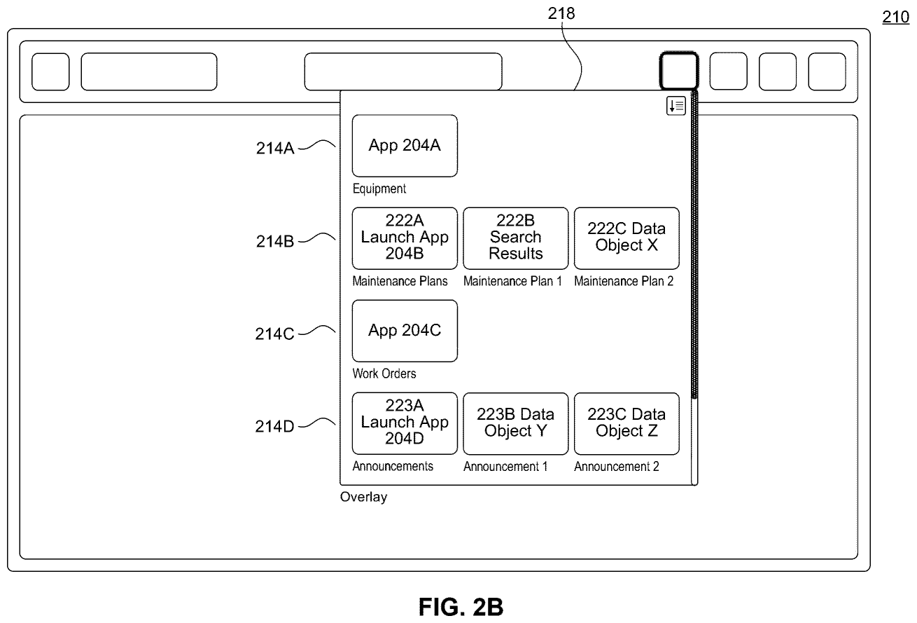

The operations list 118 may include various sequences 112 of the tracked operations requested by or inputs provided by user 106, which may be arranged chronologically or grouped by application 104. For example, a first grouping in operations list 118 may include all those actions and inputs of application 104A, and a second grouping may include all those actions and inputs of application 104B, etc. An example of these groupings is illustrated in FIGS. 2A and 2B. In some embodiments, the operations list 118 may arrange the tracked operations based on what task, project, or other business context the user 106 is working on.

In some embodiments, user 106 may have access to operations list 118 from a menu option, by pressing one or more keys, selecting an icon on Launchpad 108, etc. The operations 114 may include any number of operations/actions and/or sequences 112 as previously performed by the user 106 across the present and/or previous computing sessions. In continuing the example above, the user 106, with a single click or selection from operations list 118, may select the previously accessed sales invoice data object 117 (even if application 104A which was used to update the sales invoice is currently closed).

Upon receiving the user selection, FAST 102 may open application 104A, perform login or authentication procedures (if necessary), perform the same search or query, an open the same data object 117 from the search results. In some embodiments, these replay operations, may be performed as background processes. This may allow the user 106 to continue using the active application while the selected operation is being replayed or processed, or the selected data is being generated or retrieved from disk or cache storage.

Then when the sales invoice data object 117 is selected and opened, and ready for user access or input, the sales invoice may be displayed as an active window or new tab in user interface 109. In some embodiments, the user 106 may be prompted to switch active windows. In some embodiments, the data object 117 or a pointer to the sales invoice data object 117 may be cached and FAST 102 may retrieve the search results or data object 117 from cache, rather than replaying the previous operations of the sequence 112 or re-executing the search. In other embodiments, the search may be-executed against database 116 to retrieve any new or updated results and/or data object 117 may be re-loaded or retrieved from database 116 to ensure any data updates are included in the data object 117.

In some embodiments, the user 106 may want to select a different sales invoice from the search results, and may access the search results from the operations 114 in the operations list 118. FAST 102 may then operate in a similar manner as described, and instead returning the previously selected data object 117, FAST 102 may provide the user 106 with a screen of the search results with a single click from operations list 118. The user 106 may then select any of the data objects 117 in the search results.

In some embodiments, FAST 102 may allow a user to save a scenario 120. Scenario 120 may include a sequence 112 of one or more operations or steps. The scenario 120 may be saved to disk and persisted in a user profile, such that whenever the user 106 logs into the Launchpad 108 (from any device), the user may select the scenario 120 and FAST 102 may perform all the operations or steps of that scenario 120. This could benefit the user 106 if there are daily actions or periodic actions that the user 106 is to perform that require multiple steps, through scenario the number of steps required to perform the same actions (e.g., such as access the same data object 117) may be reduced.

FAST 102 may track which applications 104 are accessed by a user, what operations or functionality are performed by the user in each application 104, and which data object(s) 117 are accessed or updated by the user 106. FAST 102 may then make these previously performed user actions available back to the user 106 through an operations list 118 in the form of one or more operations 114A-C. Then, rather than manually re-performing all the pervious steps performed by the user 106, with a single click, FAST 102 may provide the user 106 with specific data access points in previous accessed applications 104. In some embodiments, the tracker 110 may persist these logs across user sessions and reboots, for predetermined periods of time.

The logs may include any received user inputs including keystrokes of alphanumeric characters, selection of user interface elements (buttons, menu options, etc.), and data or screens that were returned to the user (e.g., such as search results). Each of these interactions may be selectable operations 114 for the user 106 from an operations list 118.

FIGS. 2A and 2B illustrate an example user interface 210 of a fast access operations system (FAST) 102, according to some embodiments. FIG. 2A illustrates an operations list 218 (which may correspond to operations list 118 as described above with respect to FIG. 1), in which multiple operations 214A-D are illustrated (which may correspond to operations 114 as described above with respect to FIG. 1).

In some embodiments, the user interface 210 may include one of the applications 104 loaded into an active window or tab within the user interface 210. Other applications 104 may be closed, or opened in other inactive tabs or background windows of user interface 210. While operating a first application, which may be active in user interface 210, the user 106 may request operations list 218, which may include operations 214A-D across a variety of different applications 204A-D. In some embodiments, the operations list 118 may also include previously performed operations from the present or active application in user interface 210.

In the example illustrated, each operation 214 may correspond to a different application 204A-D which was accessed (e.g., from a Launchpad 108). In some embodiments, the same application 204 may be displayed twice if the application was accessed two times and a different application was accessed in between.

As illustrated with respect to app 204B and 204D, the displayed operations 214 for a particular application 204 may include multiple actions 222. In some embodiments, the actions 222 may correspond to individual or selected steps of a sequence 112. FIG. 2A may illustrate a condensed view of actions 222, while FIG. 2B illustrates an expanded view of the actions 222, as may be displayed in response to a user selection of app 204B.

In FIG. 2B, the first action 222A may correspond to a launch action of app 204B, the second action 222B may correspond to retrieving search results that were generated during a previous use of app 204B, and the third action 222C may correspond to loading a particular data object 117 that was previously accessed via app 204B. The user 106 may have the option of selecting any of the actions 222A-C, each of which may be independently accessible or selectable, or selecting a different operation 214A, 214C, or 214D.

In some embodiments, each action 222 may be cumulative to the previous actions in that row. For example, as illustrated, if user selects action 222C, then FAST 102 may perform actions 222A and 222B as part of performing action 222C.

However, as illustrated with regard to app 204D, the actions 223B and 223C may not be cumulative, but may be alternative. For example, 223B may correspond to a first data object that was accessed and 223C may correspond to a second data object that was accessed. Selecting action 223C may require launching app (action 223A) but may not require accessing data object of action 222B.

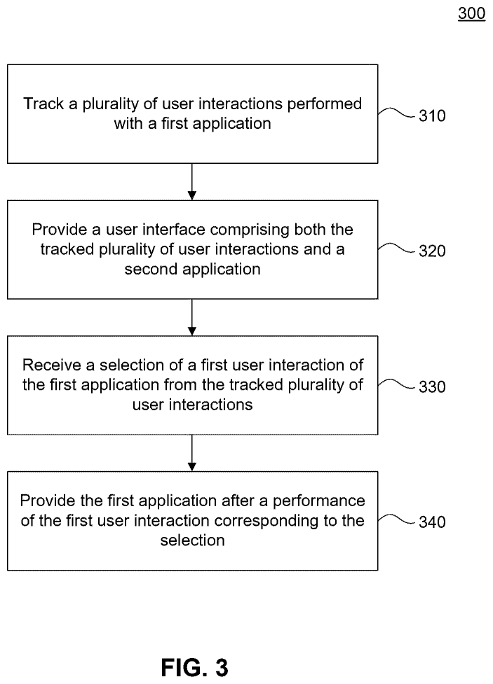

FIG. 3 is a flowchart 300 illustrating example operations for providing a fast access operations system (FAST) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

In 310, a plurality of user interactions performed with a first application are tracked. For example, operations tracker 110 may monitor user input received by Launchpad 108 with regard to launching and perform operations in different applications 104. In some embodiments, tracker 110 may track a sequence 112 of steps (112A-D) resulting in an access of a data object 117. The tracker 110 may store the sequence 112 in persistent storage or transitory memory.

In some embodiments, tracker 110 may group the operations performed in each operation together as one sequence 112 or multiple different sequences 112. In some embodiments, each sequence 112 may include one or more steps that results in a different data object 117 access (e.g., create, read, update, delete) operation.

In 320, a user interface comprising both the tracked plurality of user interactions and a second application is provided. For example, user 106 may be actively using application 104B within user interface 109, and may request operations list 118 which may include operations 114A-C from application 104A. Operations list 118 may be able to access data objects 117 which are only accessible from a first application 104A, from a second application 104B, without performing again all the steps that were previously performed in the first application 104A that were required to access the data objects 117 in the first place. In some embodiments, the operations list 118 may be provided as a separate window that is displayed simultaneous with the application 104B, or a menu option as illustrated in FIGS. 2A-2B.

In 330, A selection of a first user interaction of the first application is received from the tracked plurality of user interactions. For example, user 106 may select one of operations 114A-C which may correspond to one or more sequences 112 performed with regard to application 104A. In some embodiments, the operations list 118 may be accessible via the user interface 109 while the second application 104B is active.

In 340, the first application is provided after a performance of the first user interaction corresponding to the selection. For example, after receiving a selection of an operation 114A-C, FAST 102 may perform the selected step(s) 112A-D of the operation 114A-C as a background process. These steps 112A-D may include launching application 104A, re-entering a previously user supplied search query, receiving results from a database 116, and selecting a particular data object 117 that was previously accessed by the user 106. While these steps 112A-D are being performed in the background, the user 106 may continue operating the currently active application 104B. Once the data object 117 is ready for user access, the user interface 109 may be updated and the application 104A may be made active in a new window or tab, different from application 104B. Both applications 104A and 104B may be accessible via user interface 109. In some embodiments, the user 106 may be prompted when application 104A is ready for access, and may manually switch to the window for application 104A when they are ready at a later time.

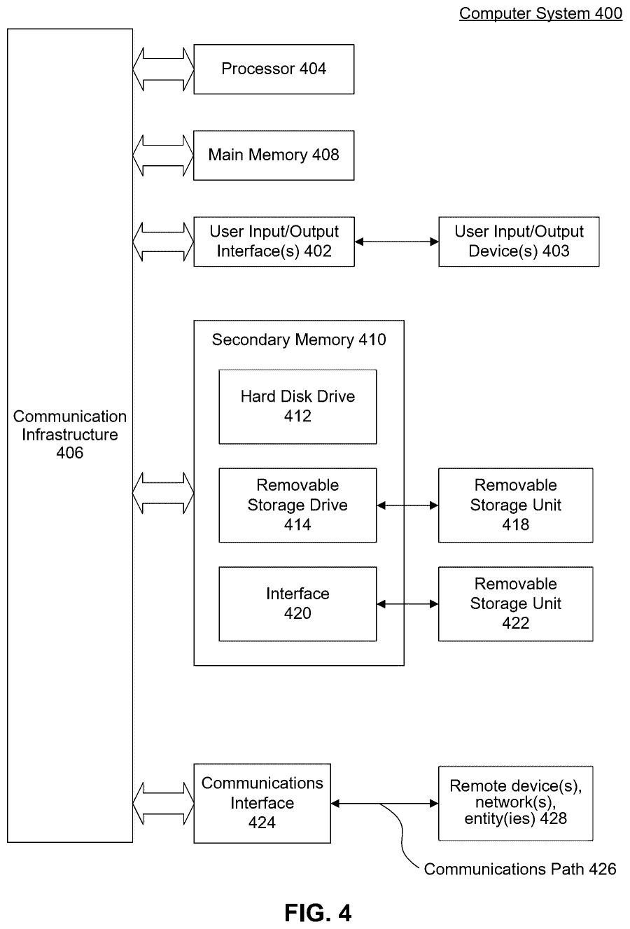

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
tracking a plurality of user interactions performed with a first application, the plurality of user interactions comprising at least accessing the first application and performing an operation within the first application;
providing a user interface comprising both the tracked plurality of user interactions and a second application, different from the first application;
receiving, via the user interface providing the second application, a selection of a first user interaction of the first application from the tracked plurality of user interactions; and
providing, via the user interface, the first application after a performance of the first user interaction corresponding to the selection, wherein both the first application and the second application are accessible via the user interface.

2. The computer-implemented method of claim 1, wherein the operation performed within the first application comprises a search operation, resulting in a set of search results.

3. The computer-implemented method of claim 2, wherein the providing the first application comprises:
generating a new set of search results based on re-executing the search operation; and
providing the new set of search results responsive to receiving the selection of the first user interaction.

4. The computer-implemented method of claim 2, wherein the providing the first
application comprises:
retrieving the set of search results from a cache; and
providing the set of search results, retrieved from the cache, responsive to receiving the selection of the first user interaction.

5. The computer-implemented method of claim 1, wherein the tracked plurality of user interactions comprises a first operation comprising performing a search operation, resulting in a set of search results, and second operation comprising accessing a data object from the set of search results, wherein both the first operation and the second operation are independently accessible via the user interface providing the second application.

6. The computer-implemented method of claim 5, wherein the providing the first application comprises:
providing the data object accessed via the first application, responsive to receiving the selection of the first user interaction, wherein the first user interaction corresponds to the second operation.

7. The computer-implemented method of claim 1, wherein both the first application and the second application are accessible from a Launchpad.

8. The computer-implemented method of claim 1, wherein the performance of the first user interaction is performed as a background process while the second application is active.

9. A system comprising:
a memory; and
at least one processor coupled to the memory and configured to perform operations comprising:
tracking a plurality of user interactions performed with a first application, the plurality of user interactions comprising at least accessing the first application and performing an operation within the first application;
providing a user interface comprising both the tracked plurality of user interactions and a second application, different from the first application;
receiving, via the user interface providing the second application, a selection of a first user interaction of the first application from the tracked plurality of user interactions; and
providing, via the user interface, the first application after a performance of the first user interaction corresponding to the selection, wherein both the first application and the second application are accessible via the user interface.

10. The system of claim 9, wherein the operation performed within the first application comprises a search operation, resulting in a set of search results.

11. The system of claim 10, wherein the providing the first application comprises:
generating a new set of search results based on re-executing the search operation; and
providing the new set of search results responsive to receiving the selection of the first user interaction.

12. The system of claim 10, wherein the providing the first application comprises:
retrieving the set of search results from a cache; and
providing the set of search results, retrieved from the cache, responsive to receiving the selection of the first user interaction.

13. The system of claim 9, wherein the tracked plurality of user interactions comprises a first operation comprising performing a search operation, resulting in a set of search results, and second operation comprising accessing a data object from the set of search results, wherein both the first operation and the second operation are independently accessible via the user interface providing the second application.

14. The system of claim 13, wherein the providing the first application comprises:
providing the data object accessed via the first application, responsive to receiving the selection of the first user interaction, wherein the first user interaction corresponds to the second operation.

15. The system of claim 9, wherein both the first application and the second application are accessible from a Launchpad.

16. The system of claim 9, wherein the performance of the first user interaction is performed as a background process while the second application is active.

17. A non-transitory computer-readable medium having instructions stored thereon that,
when executed by at least one computing device, cause the at least one computing device to perform operations comprising:
tracking a plurality of user interactions performed with a first application, the plurality of user interactions comprising at least accessing the first application and performing an operation within the first application;
providing a user interface comprising both the tracked plurality of user interactions and a second application, different from the first application;
receiving, via the user interface providing the second application, a selection of a first user interaction of the first application from the tracked plurality of user interactions; and
providing, via the user interface, the first application after a performance of the first user interaction corresponding to the selection, wherein both the first application and the second application are accessible via the user interface.

18. The non-transitory computer-readable medium of claim 17, wherein the operation performed within the first application comprises a search operation, resulting in a set of search results.

19. The non-transitory computer-readable medium of claim 18, wherein the providing the first application comprises:
generating a new set of search results based on re-executing the search operation; and
providing the new set of search results responsive to receiving the selection of the first user interaction.

20. The non-transitory computer-readable medium of claim 18, wherein the providing the
first application comprises:
retrieving the set of search results from a cache; and
providing the set of search results, retrieved from the cache, responsive to receiving the selection of the first user interaction.
